(19) United States
(12) Patent Application Publication
(10) Pub. No.: US 2020/0193454 A1
(43) Pub. Date: Jun. 18, 2020

(54) Method and Apparatus for Generating Target Audience Data

(71) Applicants: Qingfeng Zhao, Foster City, CA (US); Man Feng, Foster City, CA (US); Chenyu Wang, Foster City, CA (US)

(72) Inventors: Qingfeng Zhao, Foster City, CA (US); Man Feng, Foster City, CA (US); Chenyu Wang, Foster City, CA (US)

(21) Appl. No.: 16/218,064

(22) Filed: Dec. 12, 2018

(51) Int. Cl. G06Q 30/02; G06F 16/903

(52) U.S. Cl. CPC G06Q 30/0201; G06F 16/90335; G06Q 30/0269

(57) ABSTRACT

A apparatus and method is disclosed for generating target audience data. In one embodiment one or more query logic modules among a plurality of query logic modules are configured based on one or more target audience parameters. Each query logic module is associated with a target audience type. The one or more configured query logic modules generate target audience data. In one embodiment, the target audience data is tested based on merchant confidentiality rules. If the merchant confidentiality rules are not satisfied, the target audience data is sampled in accordance with a sampling technique to ensure compliance with such rules. In another embodiment, the target audience data or the sampled target audience data is scrubbed based on rules pertaining to the degree to which consumer-identifying information (e.g., zip code data) may be retained.

### BACKGROUND

The present disclosure relates to target audience data generating apparatus and methods, and more particularly to target audience data generation apparatus and methods associated with configurable query logic modules.

### SUMMARY

A method and apparatus for generating target audience data (e.g., for advertisers and marketers) is disclosed. The method and apparatus may include configuring a first set of query logic modules based on determinative target audience parameters. Each query module may be associated with a target audience type (e.g., consumers who engage in air travel, consumers who purchase electronic devices, etc.) to search a first set of one or more data sources (e.g., credit card transaction databases, proprietary databases, subscription databases, etc.) to generate deterministic target audience data. The deterministic target audience data may include a population of consumers who have engaged in or will engage in a particular activity or conduct described in or related to the target audience parameters.

In one embodiment, the method and apparatus may include using the determinative target audience data to identify one or more common or similar characteristics of the uncovered population to generate predictive target audience parameters. A second set of query logic modules may be configured using predictive target audience parameters to query a second set of one or more data sources to generate predictive target audience data. The predictive target audience data may include a population of consumers who have not engaged in but may engage in a particular activity or conduct described in or related to the original (deterministic) target audience parameters.

The disclosure contemplates the generation of deterministic target audience data, predictive target audience data, or both deterministic and predictive target audience data. In one embodiment, additional logic and/or method steps may be employed to ensure confidentiality and integrity of the target audience data. For example, merchant confidentiality logic may test target audience data for compliance with merchant confidentiality rules. If such rules are not satisfied, sampling logic may sample the target audience to ensure compliance. Similarly, consumer privacy logic may scrub the target audience data to ensure compliance with consumer privacy rules regarding the retention of personal identifying information in the target audience data.

In one embodiment the configuration logic, query logic modules, and plurality of data source are implemented in a distributed environment such as two or more nodes in a computer cluster.

### BRIEF DESCRIPTIONS OF THE DRAWINGS

The detailed description refers to the following Figures in which:

FIG. 1 is a schematic block diagram depicting an example of an apparatus for generating target audience data in accordance with one embodiment of the present disclosure;

FIG. 2 is a schematic block diagram depicting an exemplary of distributed apparatus or environment for generating target audience data in accordance with another embodiment of the present disclosure; and

FIG. 3 is a flow chart depicting an exemplary method of using the apparatus of FIG. 1 or FIG. 2 in accordance with one embodiment of the present disclosure.

### DETAILED DESCRIPTION

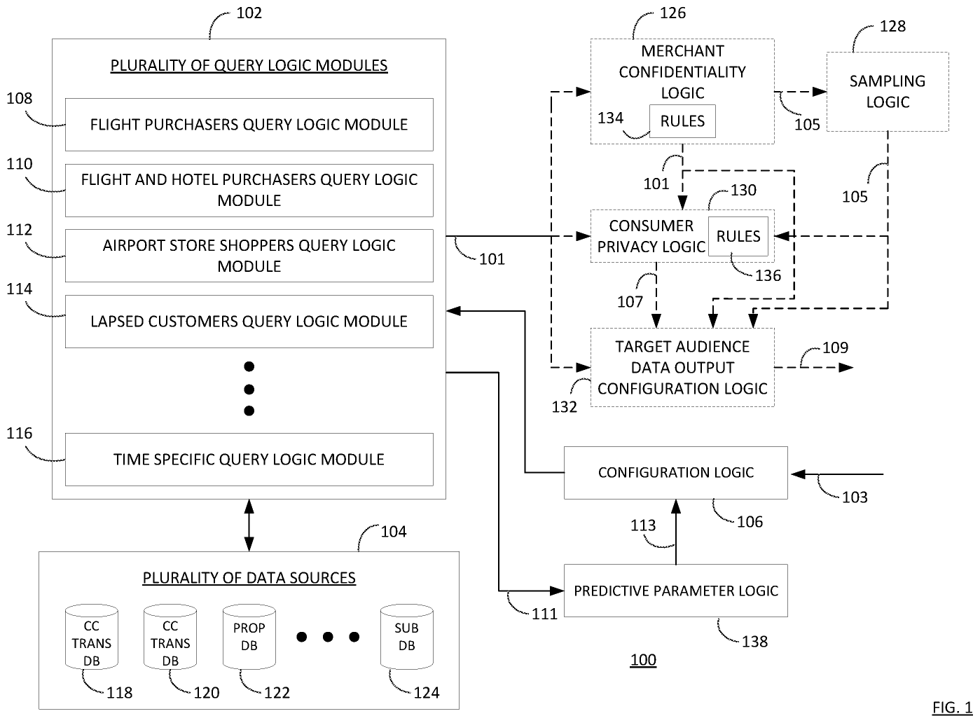

FIG. 1 is a schematic block diagram depicting an example of an apparatus 100 for generating target audience data 101 in accordance with one embodiment of the present disclosure. The apparatus 100 includes a plurality of query logic modules 102 operably coupled to a plurality of data sources 104 and configuration logic 106. In one embodiment, each query logic module 108-116 within the plurality of query logic modules 102 is associated with a particular target audience type. For example, query logic module 108 may be associated with airline flight purchasers, query logic module 110 may be associated with airline flight purchasers who happen to be hotel purchasers, query logic module 112 may be associated with airport store shoppers, query logic module 114 may be associated with lapsed customers, and query logic module 116 may be associated with purchasers who purchased goods or services within a particular time period. Other audience types are contemplated and within the scope of the disclosure.

Configuration logic 106 is operative to receive one or more target audience parameters 103 and to configure one or more query logic module 108-116 of the plurality of query logic modules 102 based on such parameters 103. In one embodiment target audience parameters 103 are input via a graphical user interface (not shown). In turn, the configured one or more query logic modules 108-116 are operable to query one or more data sources 118-124 of the plurality of data sources 104 to generate target audience data 101.

In one embodiment, the one or more target audience parameters 103 may include an identification of a target audience (e.g., flight purchasers, flight and hotel purchasers, airport store shoppers, etc.), and a number of other parameters that may identify features or characteristics of customers/consumers within a particular audience type. Such parameters may include: a demographic parameter identifying a specific customer/consumer demographic within the target audience (e.g., age, sex, ethnicity, etc.), a conduct parameter identifying a conduct associated with a target audience (e.g., air travel, hotel stay, airport shopping, purchase with a particular merchant, purchase with a merchant type, etc.), a location parameter identifying a location at which the conduct (e.g., an activity or transaction) has or will occur (e.g., a specific airport, a zip code, a city, a street, etc.), a merchant parameter identifying a merchant name or merchant type with which a purchase has been made (e.g., Best Buy or electronics retailer stores) a behavioral parameter identifying how the conduct (e.g., activity or transaction) has or will be conducted (e.g., method of payment, technology associated with payment, etc.), and a date parameter identifying a date range for the conduct (e.g., an activity or transaction).

If the target audience parameters 103 identify a target audience, then configuration logic 106 may configure the corresponding one or more query logic modules 108-116 corresponding to identified target audience. If, however, the desired target audience parameters 103 do not identify a target audience, then configuration logic 106 may ascertain the target audience using one or more parameters within the target audience parameters 103. For example, if the associated conduct parameters identify air travel and hotel bookings, then the target audience might be “flight and hotel purchasers.” The present disclosure contemplates inclusion of any suitable algorithm for associating parameters with target audience type.

The plurality of data sources 104 may include credit card transaction databases 118-120 maintained by a card association such as Visa, MasterCard, AmericanExpress, or DiscoverCard, proprietary databases 122 maintained by the owner and/or operator of the apparatus 100, and subscription databases 124 maintained by one or more third parties such as a specific airline, hotel, restaurant, a grocery chain, or an industry specific organization to which a given merchant type might belong (e.g., an oil industry organization whose members are the various oil and gas companies or a frequency flyer program where points may be accumulated for miles travelled via multiple airline carriers (i.e., so-called partner airlines).

With respect to the querying capabilities of the configured plurality of query logic modules 102 and the target audience data 101 generated thereby, a configured flight purchasers query logic module 108 may be capable of querying one or more credit card transaction databases 118-120 and a subscription airline database 124 to generate target audience data 101 that identifies a population that engaged or will engage in air travel to a given location within a given period of time. For example, credit card transaction databases 118-120 may be queried to capture the population that purchased a ticket with an airline within a given period of time. By cross referencing those records with one or more subscription airline databases 124, airport departure and destination codes might be identified and departure dates may be identified.

Similarly, a configured flight and hotel purchasers query logic module 110 may be capable of querying one or more credit card transaction databases 118-120, one or more subscription airline databases 124 and one or more subscription hotel (or other boarding industry) databases 124 to identify a population that engaged or will engage in air travel and has paid or will pay for boarding (e.g., at a hotel, inn, bed and breakfast, etc.) within a given period of time. By way of example, a configured airport store shoppers query logic 112 may be capable of querying and cross-reference one or more credit card transaction databases 118-120 and one or more subscription airline database 124 to capture the population who travelled to a specific location using airport codes and made purchases within the defined airport. Airport codes, zip code data, dates, Merchant Category Code, Sub-DBA, and Global Merchant Repository IDs may be identified and cross-referenced in one example. The result may be target audience data 101 that has made or will make a purchase with a given merchant or merchant type (e.g., an electronics merchant) located at or near a given airport (e.g., in the terminal or within a given distance of the airport) during a given period of time.

The other exemplary query logic modules may be similarly capable of querying the one or more data sources 118-124. For example, a configured lapsed customer query logic module 114 might be capable of querying one or more credit card transaction databases 118-120 to identify a population that made a purchase with a specific merchant or merchant type during a given period of time but that has not made a purchase with the same merchant or same merchant type during a another given period of time (i.e., the population consists of customers who are lapsed customers). A configured time specific query logic module 116 may query one or more credit card transaction databases 118-120 and a proprietary time mapping database 122 to identify the population that made a purchase with a specific merchant at a specific local time. Here, the time mapping database 122 may be queried to translate GMT time to local time.

In one embodiment, the apparatus 100 may include optional post-population identification logic such as merchant confidentiality logic 126, sampling logic 128, consumer privacy logic 130, and target audience data output configuration logic 132. For example, merchant confidentiality logic 126 may test whether the target audience data satisfies one or more predetermined merchant confidentiality rules 134. Merchant confidentiality rules 134 may include one or more rules that seek to prevent or limit the ability of any end user of such target audience data 101 to be able to ascertain the identity of any merchant responsible for or identified in any target audience data 101. For example, rules 134 may seek to ascertain whether the target audience data 101 includes data from less than a predetermined number of merchants. In another embodiment, rules 134 may seek to ascertain whether the target audience data 101 is biased in favor of one or more merchants. For example, whether any given merchant identified in the target audience is associated with more than a predetermined percentage of transactions identified in the target audience.

If rules 134 are not satisfied, then sampling logic 128 may generate sampled target audience data 105 based on the target audience data 101. Sampled target audience data 105 may selectively sample aspects of the target audience data 101 to ensure that rules 134 are satisfied. For example if rules 134 require that no merchant associated with target audience data 101 may be responsible for more than 20% of the transactions associated with target audience data 101, and x number of merchants associated with data 101 are responsible for more than 20% of the transactions in data 101, then sampling logic 128 may equitably eliminate from target audience data 101 certain entries associated with the x number of merchants so that rules 134 are satisfied.

In another embodiment, rules 134 may require that target audience data 101 must include data associated with more than y number of merchants. If data 101 does not satisfy such rule, sampling logic 128 may reject the target audience data 101 or request that the one or more query modules 108-116 responsible for generating target audience data 101 broaden their query with respect to the one or more data sources 118-124. For example, the one or more query modules 108-116 may query such data sources 118-124 for longer time periods, or may seek to identify related merchants, merchant types, airport locations, etc. Upon generation of additional or revised target audience data 101, merchant confidentiality logic 126 may re-test data 101 for compliance with rules 134 as described above.

If consumer privacy logic 130 is implemented, a second privacy test may be performed on either the target audience data 101 or the sampled audience data 105 using consumer privacy rules 136 to generate scrubbed audience data 109. Consumer privacy rules 136 may relate to the degree to which consumers identified in target audience data are readily identifiable. For example, rules 136 may define the degree to which personal identifying information may be retained in the target audience data 101 and sampled target audience data 107. In one embodiment, consumers may be identified in audience data 101, 107 by zip code. And rules 136 may require that such no audience data 101, 107 may include more than n number of zip code digits. For example, if n is set to 7 then the consumer privacy logic may scrub the target audience data 101 and/or the sampled target audience data 107 to ensure that the last two digits of the 9-digit zip codes are removed from the data. Other consumer privacy rules 136 may be implemented.

In one embodiment, the one or more target audience parameters 103 may include confidentiality and/or privacy parameters that determine whether merchant confidentiality rules 134 and/or consumer privacy rules 136 should be applied to test the target audience data 101 using corresponding merchant confidentiality logic 126 and consumer privacy logic 130. Target audience data output configuration logic 132 may format audience data 101, 105, and/or 107 for output 109. Formatting may be selectable based on additional information conveyed together with target audience parameters 103 and/or otherwise predetermined.

As explained, query logic modules 108-116 may generate target audience data based on the target audience parameters 103 used to configure such modules 108-116. That is, the populations identified constitute those individuals who exhibit or who have exhibited the target audience parameters 103. In other words, such individuals “meet” the parameter 103. As such, the populations identified in the target audience data 101 and the related target audience parameters 103 may be considered “deterministic.” However, in one embodiment, target audience data 101 may include “predictive” target audience data 101, either alone or together with “deterministic” target audience data 101. In this embodiment, for example, configuration logic 106 and the plurality of query logic modules 102 may first generate deterministic target audience data 111. In turn, predictive parameter logic 138 may process the deterministic target audience data 111 to uncover one or more common or similar characteristics within the deterministic target audience data 111 and thereby generate predictive target audience parameters 113. Configuration logic 106 may re-configure the one or more plurality of query logic modules based on the predictive target audience parameters 113 to generate predictive target audience data 101.

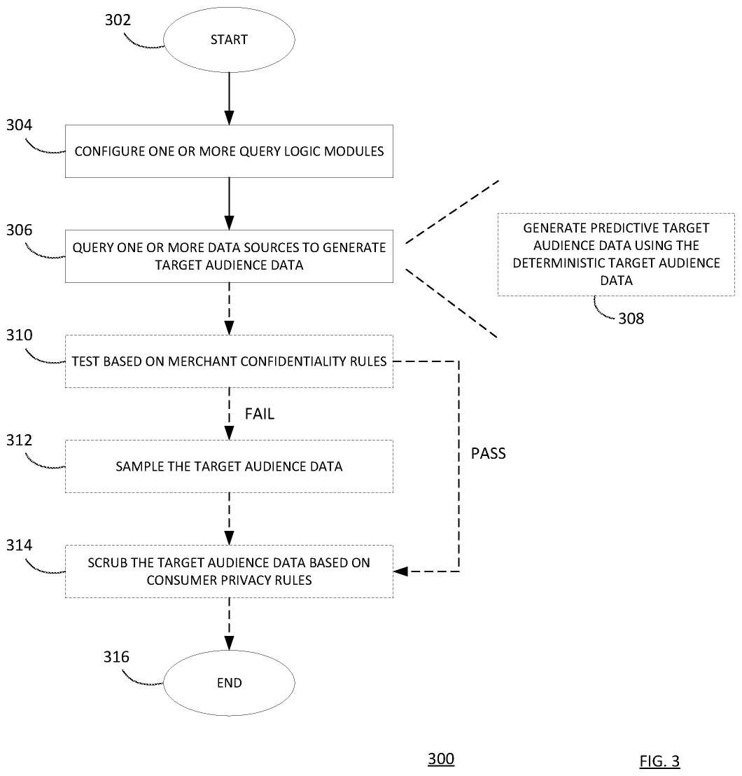

For example, and with respect to method 300 of FIG. 3, if the one or more target audible parameters 103 are set or received in step 302 so as to identify a population of golfers who will travel to a warm weather resort during the winter months to play golf, then a first set of one or more query logic modules 108-116 of the plurality of query logic modules 102 may be configured in step 304, e.g., by configuration logic 106, to query a first set of data sources 118-124 in the plurality of data sources 104 to generate target audience data in step 306. If the target audience parameters 103 include a parameter indicating that the apparatus 100 or method 300 should include predictive audience data, then apparatus 100 and method 300 will interpret the target audience parameters 103 as deterministic target audience parameters and will further interpret target audience data as deterministic target audience data 111.

In turn, predictive target audience parameters 113 may be generated in optional step 308 based on the deterministic target audience data 111 using, for example, predictive parameter logic 138. In turn, one or more query logic modules 108-116 will be configured based on the predictive target audience parameters 113 to query a second set of data sources 118-124 of the plurality of data sources 104 to generate predictive target audience data 101. In this example, where the deterministic target audience parameters 103 related to golfers who will travel in the winter to warm weather results to play golf, the predictive parameter logic 138 may uncover one or more common or similar characteristics associated with the population (or percentage thereof) identified in the deterministic target audience data 111. For example, a significant number of individuals in such population may have paid for more than a predetermined number of rounds of golf in the last three months and may have paid dues within the past year at a private golf club using their credit card. Alternatively and/or additionally, a number of individuals in the population may have paid for member in a private tennis club or public park district tennis league using their credit card. Once uncovered, these common or perhaps merely similar characteristics may be used to generate predictive target audience parameters 113, which can be used to query and uncover other individuals who may not have already engaged in warm weather golf trip, but who might consider booking such an experience given their shared interests/behaviors/conduct with the population identified in the deterministic target audience data. One of skill in the art will recognize that the predictive parameter logic 113 may be employed to identify a host of corresponding shared interests/behaviors/conduct, and that the parameters described above were merely exemplary.

In one embodiment, the first and second sets of query logic modules configured in response to deterministic target parameters 103 and predictive target parameters 113 are mutually exclusive. That is, entirely different modules are used to generated deterministic target audience data 111 than used to generate predictive target audience data 101. In other embodiments, the modules may be the same. In yet other embodiments, there may be some, but not complete overlap regarding the re-use of the modules. The same is true with respect to the first and second sets of one or more data sources 118-124 queried by the first and second sets of one or more query logic modules.

Returning to FIG. 3, the method may then continue in optional steps 310-312 to act upon target audience data 101 to test the target audience data with respect to merchant confidentiality rules (e.g., by merchant confidentiality logic 126) and to sample the target audience data if the test is unsuccessful (e.g., by sampling logic 128). Finally, optional step 314 may scrub target data for compliance with consumer privacy rules (e.g., using consumer privacy logic 130). The method may conclude in step 316 with the target audience data being formatted for output (e.g., by target audience data output configuration logic 132).

As suggested above, the target audience data 101 may be deterministic, predictive, or both. And the post-population identification logic 126-132 (corresponding to steps 310-316) may operate on either deterministic, predictive, or both deterministic and predictive target audience data 101.

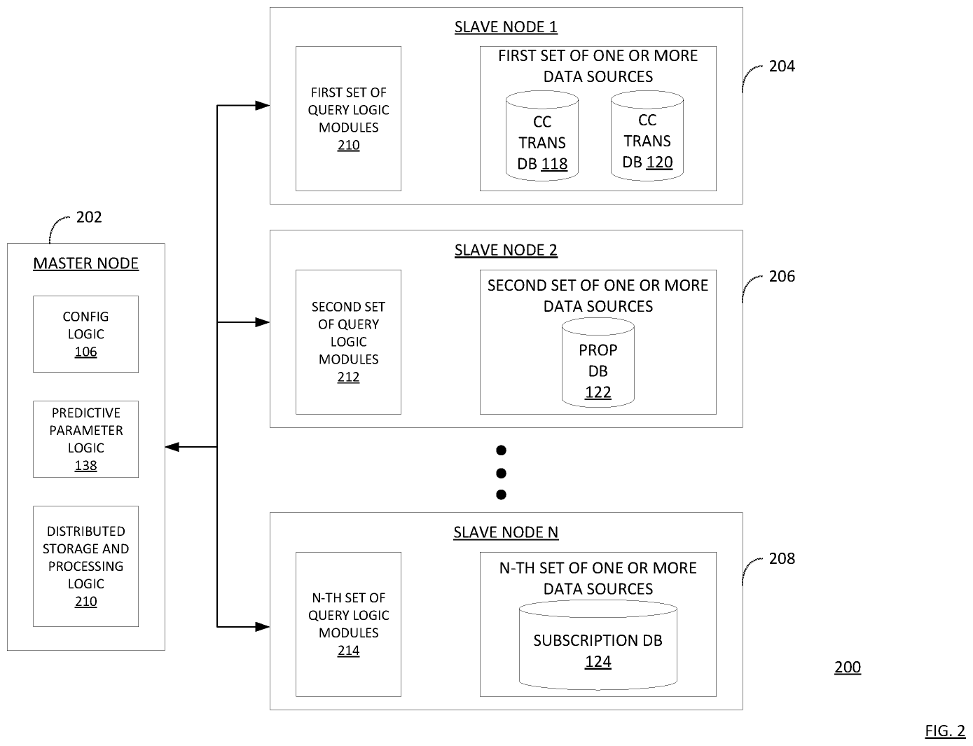

Turning to FIG. 2, the apparatus 100 may be implemented in a distributive environment such as environment 300. In particular, environment 300 may include a master node 202 and one or more slave nodes 204-208 arranged in a computer cluster. Master node 202 may include configuration logic 106, predictive parameter logic 138, and distributed storage and processing logic 210. Each slave node 204-208 may include a set of one or more query logic modules 210-214. The sets 210-214 may be mutually exclusive or overlapping. Each slave node 204-208 may further include one or more sets of data sources corresponding to the query logic modules associated with the slave nodes 204-208. Distributed storage and processing logic 201 may manage the storage of data within the data sources associated with slave nodes 204-208 and likewise manage the distributed processing of such data.

The present disclosure provides an unconventional and tangible technical solution to a technical problem of efficiently searching disjointed databases and data sources of credit card transactions and other information concerning consumers to generate deterministic and predictive target audiences consistent with one or more target audience parameters. By employing configuration logic and query logic modules associated with specific data sources, such parameters can be used to quickly configure and deploy the re-usable query logic modules to identify one or more populations associated with the target audience parameters. For example, predictive parameter logic may be employed to increase the effectiveness of the described method and apparatus to ensure that not one or both of a deterministic population and a predictive population is uncovered. Finally, by deploying the query logic in a distributed environment (e.g., in nodes in a cluster) it is possible to realize additional benefits of parallel processing a data storage and data processing redundancies.

As used herein, the following terms have the meanings described thereto as set forth below. “Logic” and “module” may refer to any single or collection of circuit(s), integrated circuit(s), hardware processor(s), processing device(s), transistor(s), non-transitory memory(s), storage devices(s), non-transitory computer readable medium(s), combination logic circuit(s), or any combination of the above that is capable of providing a desired operation(s) or function(s). For example, “logic” and “module” may each take the form of a hardware processor executing instructions from one or more non-transitory memories, storage devices, or non-transitory computer readable media, or a dedicated integrated circuit. “Non-transitory memory,” “non-transitory computer-readable media,” and “storage device” may refer to any suitable internal or external non-transitory, volatile or non-volatile, memory device, memory chip(s), or storage device or chip(s) such as, but not limited to system memory, frame buffer memory, flash memory, random access memory (RAM), read only memory (ROM), a register, a latch, or any combination of the above. A “hardware processor” may refer to one or more dedicated or non-dedicated: hardware micro-processors, hardware micro-controllers, hardware sequencers, hardware micro-sequencers, digital signal hardware processors, hardware processing engines, hardware accelerators, applications specific circuits (ASICs), hardware state machines, programmable logic arrays, any integrated circuit(s), discreet circuit(s), etc. that is/are capable of processing data or information, or any suitable combination(s) thereof. A “processing device” may refer to any number of physical devices that is/are capable of processing (e.g., performing a variety of operations on) information (e.g., information in the form of binary data or carried/represented by any suitable media signal, etc.). For example, a processing device may be a hardware processor capable of executing executable instructions, a desktop computer, a laptop computer, a mobile device, a hand-held device, a server (e.g., a file server, a web server, a program server, or any other server), any other computer, etc. or any combination of the above. An example of a processing device may be a device that includes one or more integrated circuits comprising transistors that are programmed or configured to perform a particular task. “Executable instructions” may refer to software, firmware, programs, instructions or any other suitable instructions or commands capable of being processed by a suitable hardware processor. In one embodiment, each of the query logic modules 108-116 of the plurality of query logic modules 102 are implemented as Apache Hive modules, which are configurable based on the execution of one or more Python scripts generated by configuration logic 106. And the processing of such Apache Hive modules is implemented on a Hadoop open source platform.

What is claimed:

1. An apparatus comprising:
a plurality of query logic modules, each query logic module being associated with a target audience type;
configuration logic operable to configure one or more query logic modules of the plurality of query logic modules based on one or more target audience parameters, the configured first set of query logic modules being operable to query one or more data sources of a plurality of data sources to generate target audience data;
merchant confidentiality logic operable to test whether the target audience data satisfies predetermined merchant confidentiality rules;
sampling logic operable to sample the target audience data to generate sampled target audience data when the merchant confidentiality logic determines that the target audience data does not satisfy the predetermined merchant confidentiality rules; and
consumer privacy logic operable to scrub one of the target audience data and the sampled target audience data based on one or more predetermined consumer privacy rules regarding retention of personal identifying information in one of the target audience data and sampled target audience data.

2. The apparatus of claim 1, wherein the merchant confidentiality logic is operative to determine that the target audience data does not satisfy the predetermined merchant confidentiality rules when any merchant identified in the target audience data is associated with more than a predetermined percentage of transactions identified in the target audience data.

3. The apparatus of claim 1, wherein the one or more data sources include data associated with credit card transactions.

4. The apparatus of claim 1, wherein the consumer privacy logic is operable to scrub the target audience data when the merchant confidentiality logic determined that the target audience data satisfied the predetermined merchant confidentiality rules and to scrub the sampled target audience data when the merchant confidentiality logic determined that the target audience data did not satisfy the predetermined confidentiality rules.

5. The apparatus of claim 1, wherein the configuration logic is further operable to select the one or more of the plurality of query modules for configuration based on one or more desired target audience parameters.

6. The apparatus of claim 1, wherein the one or more target audience parameters includes one of more of the following parameters: an identification parameter identifying a demographic of a target audience, a conduct parameter identifying a conduct associated with the target audience, a location parameter identifying a location at which the conduct has or will occur, a merchant parameter identifying a merchant or merchant type associated with the conduct, a behavioral parameter identifying how the conduct has or will be transacted, and a date parameter identifying a date range for when the conduct or will occur.

7. The apparatus of claim 1, wherein at least a portion of the target audience data represents consumers who have exhibited the target audience parameters during a predetermined period of time in the past.

8. The apparatus of claim 1, wherein:
the one or more target audience parameters include one or more predictive target audience parameters;
the configured one or more query logic modules is a second set of one or more query logic modules and wherein the queried one or more data sources is a second set of one or more data sources;
the target audience data includes predictive target audience data; and
the configuration logic is further operative to configure a first set of one or more query logic modules of the plurality of query logic modules based on one more deterministic target audience parameters, the configured first set of query logic modules being operative to query a first set of one or more data sources of the plurality of data sources to generate deterministic target audience data, the apparatus further comprising predictive parameter logic operable to generate the one or more predictive target audience parameters based on one or more common characteristics of the deterministic target audience data.

9. The apparatus of claim 7, wherein:
at least one query logic module of the first set of one or more query logic modules was configured by configuration logic to query the first set of one or more data sources and re-configured by configuration logic to query the second set of one or more data sources; and
at least one data source was queried by the first set of one or more query logic modules and re-queried by the second set of one or more query logic modules.

10. The apparatus of claim 7, wherein the target audience data includes deterministic target audience data and predictive target audience data.

11. The apparatus of claim 1, wherein the plurality of data sources are distributed across one or more nodes in a computer cluster.

12. The apparatus of claim 11, wherein:
the plurality of query logic modules and the plurality of data sources are implemented in a distributed data storage and processing platform such that at least one query logic module and at least one corresponding data source of the plurality of data sources exists on each node in the computer cluster, and
configuration logic is further operable to configure the at least one query logic module on each node in the computer cluster.

13. The apparatus of claim 11, the apparatus further comprising distributed storage and processing logic operable to manage the storage of data within the plurality of data sources and the distributed processing of data stored within the plurality of data sources.

14. The apparatus of claim 1, wherein at least one of the plurality of query logic modules is:
a flight purchasers query logic module operable to identify a first population that engaged or will engage in air travel to a first location within a first period of time;
a flight and hotel purchasers query logic module operable to identify a second population that engaged or will engage in air travel to a second location and has paid or will pay for boarding in a third location within a second period of time;
an airport store shoppers query logic module operative to identify a third population that has made or will make a purchase with a first merchant or first merchant type located at an airport during a third period of time;
a lapsed customers query logic module operative to identify a fourth population that made a purchase with a second merchant or second merchant type during a fourth period of time but who has not made a purchase with the second merchant or the second merchant type during a fifth period of time; and
a time specific query logic module operative to identify a fifth population that made a purchase with a third merchant or third merchant type during a sixth period of time.

15. The apparatus of claim 1, wherein:
the apparatus is non-transitory computer readable medium; and
each of the configuration logic, the plurality of query logic modules, merchant confidentiality logic, sampling logic, and consumer privacy logic are implemented as computer readable instructions stored on the non-transitory computer readable medium and capable of being executed by one or more hardware processors.

16. The apparatus of claim 8, wherein the predictive parameter logic is implemented as computer readable instructions stored on the non-transitory computer readable medium and capable of being executed by the one or more hardware processors.

17. A method performed by one or more hardware processors, the method comprising:
configuring one or more query logic modules of a plurality of query logic modules based on one or more target audience parameters, each query logic module being associated with a target audience type;
using the configured one or more query logic modules to query one or more data sources of a plurality of data sources to generate target audience data;
testing whether the target audience data satisfies predetermined merchant confidentiality rules;
sampling the target audience data to generate sampled target audience data when the target audience data does not satisfy the predetermined merchant confidentiality rules; and
scrubbing one of the target audience data and the sampled target audience data based on one or more predetermined consumer privacy rules regarding retention of personal identifying information in one of the target audience data and the sampled target audience data.

18. The method of claim 17, wherein the target audience data does not satisfy the predetermined merchant confidentiality rules when any merchant identified in the target audience data is associated with more than a predetermined percentage of transactions identified in the target audience data.

19. The method of claim 17, wherein:
the one or more target audience parameters include one or more predictive target audience parameters;
the configured one or more query logic modules is a second set of one or more query logic modules and wherein the queried one or more data sources is a second set of one or more data sources;
the target audience data includes predictive target audience data; and
the method further comprising:
configuring a first set of one or more query logic modules of the plurality of query logic modules based on one more deterministic target audience parameters, the configured first set of query logic modules being operative to query a first set of one or more data sources of the plurality of data sources to generate deterministic target audience data; and
generating the one or more predictive target audience parameters based on one or more common characteristics of the deterministic target audience data.

20. The method of claim 17, wherein querying the one or more data sources among a plurality of data sources includes:
identifying a first population that engaged or will engage in air travel to a first location within a first period of time;
identifying a second population that engaged or will engage in air travel to a second location and has paid or will pay for boarding in a third location in a second period of time;
identifying a third population that has made or will make a purchase with a first merchant or first merchant type located at an airport during a third period of time;
identifying a fourth population that made a purchase with a second merchant or second merchant type during a fourth period of time but who has not made a purchase with the second merchant or second merchant type during a fifth period of time; and
identifying a fifth population that made a purchase with a third merchant or third or third merchant type during a sixth period of time.
